(19) United States
(12) Patent Application Publication
(10) Pub. No.: US 2026/0184232 A1
(43) Pub. Date: Jul. 2, 2026

(54) POWER ALLOCATION IN RELATION TO A POWER DEMAND FOR MULTI-UNIT VEHICLE COMBINATIONS

(71) Applicant: VOLVO TRUCK CORPORATION, Göteborg (SE)

(72) Inventors: Esteban GELSO, Västra Frölunda (SE); Maliheh SADEGHI KATI, Partille (SE); Leo LAINE, HÄRRYDA (SE)

(73) Assignee: VOLVO TRUCK CORPORATION, Göteborg (SE)

(21) Appl. No.: 19/130,742

(22) PCT Filed: Nov. 17, 2022
(86) PCT No.: PCT/EP2022/082327

§ 371 Date: May 16, 2025

(51) Int. Cl. B60L 58/22; B60L 7/10; B60L 15/20; B60L 15/32; B60L 58/13; B60L 58/16

(52) U.S. Cl. CPC B60L 58/22; B60L 7/10; B60L 15/2045; B60L 15/32; B60L 58/13; B60L 58/16; B60L 2200/36; B60L 2240/54

(57) ABSTRACT

A computer-implemented method determines a power allocation for a vehicle combination comprising a tractor unit and at least one trailing unit is disclosed. The method includes receiving a power demand for the vehicle combination, determining a respective power delivery from one or more batteries of the vehicle combination, and determining a power allocation for one or more units of the vehicle combination such that a cumulative power delivered from the batteries is below a threshold. The total power allocation of the individual units meets the received power demand for the vehicle combination.

### TECHNICAL FIELD

The disclosure relates generally to vehicle control. In particular aspects, the disclosure relates to power allocation in relation to a power demand for a vehicle combination. In some examples, the disclosure relates to a system and method for determining a power demand allocation for batteries distributed across multiple units of a vehicle combination. The disclosure can be applied in heavy-duty vehicles, such as trucks, buses, and construction equipment. In particular, the disclosure can be applied in multi-unit vehicle combinations with distributed propulsion and energy storage. Although the disclosure may be described with respect to a particular vehicle, the disclosure is not restricted to any particular vehicle.

### BACKGROUND

The total global carbon emissions footprint of humans has increased exponentially over the past decades. It is expected to keep increasing in the years to come. In 2020, the road transport sector, which includes heavy-duty trucks used in, for instance, construction, logging and refrigeration, were estimated to account for 5% of total global CO2 emissions and 30% of global CO2 emissions in the transport sector. As such, research of battery electric vehicles is a popular topic in the heavy vehicle industry, as they serve as an environmentally sustainable alternative to combustion engines that run on fossil fuels. Several companies in the heavy vehicle industry aim to reach a point in the near future where they only sell and produce vehicle combinations that use electrical power as the main source of propulsion.

In traditional vehicle combinations, for example semi-trailers, a tractor unit may provide propulsion for the entire combination, while trailer units are towed behind. Traditional vehicle combinations may employ internal combustion engines in a tractor unit to provide propulsion. In battery electric vehicle combinations, batteries may be installed in the tractor unit to power electric motors and provide propulsion. If batteries are also installed in the trailer of a vehicle combination, electrical motors may also be installed so that the trailer can be used as a propulsive complement to the combination. This allows the use of an electric trailer with both tractors having internal combustion engines and battery electric vehicle tractors. Furthermore, conventional heavy vehicle trailers are normally installed with pneumatic brakes to make the vehicle stop safely and in time. An electric trailer could also be used to recharge the batteries through regenerative braking, thus preventing wasting energy through the mechanical braking system.

One issue with vehicle combinations having a plurality of batteries distributed across various vehicle units is finding a balance between the batteries in order to fulfil a power demand. The performance and properties of the battery packs can be affected by a lack of balance between them. For instance, when the packs are distributed between units of a vehicle combination, any difference in energy buffers between units may lead to differences in how much energy can be regenerated when the vehicle is decelerating, which may in turn affect the efficiency and range of the vehicle. Instead, service brakes need to be used in some of the vehicle units to maintain the balance of coupling forces between units. Similarly, the lack of balance between cells in a battery pack may result in degraded battery properties, which needs to be corrected through a cell balancing process.

It is therefore desired to develop a solution for power demand allocation for vehicle combinations. Preferably, such a solution for power demand allocation addresses or at least mitigates some of these issues.

### SUMMARY

This disclosure attempts to solve the problems noted above by providing methods for controlling multi-unit vehicle combinations with distributed propulsion and energy storage. In particular, a power flow model is used to describe the power sources and losses involved in the motion of a multi-unit vehicle combination to determine an optimised power split between different units.

One way to determine an optimal power split is by ensuring power delivered from the batteries during propulsion is below a threshold, which may include minimising power delivered from the batteries during propulsion, and/or maximising power recovered by the batteries during regenerative braking. In particular, a power allocation for individual units of a vehicle combination is determined such that the cumulative power delivered from the batteries the vehicle combination is below a threshold.

According to an aspect of the disclosure, there is provided a computer-implemented method for determining a power allocation for a vehicle combination comprising a tractor unit and at least one trailing unit, the method comprising receiving a power demand for the vehicle combination, determining a respective power delivery from one or more batteries of the vehicle combination; and determining a power allocation for one or more units of the vehicle combination such that a cumulative power delivered from the batteries is below a threshold, wherein the total power allocation of the individual units meets the received power demand for the vehicle combination.

This method may enable a power allocation to be determined for a vehicle combination that reduces the power delivered from the batteries. This may ensure efficient operation of the vehicle combination and that battery life can be increased. This may be performed on a unit basis, such that an efficient distribution of the power demand is determined to fulfil the power requirement of the vehicle combination.

Optionally, the power delivery from a battery comprises a power delivered from the battery during propulsion, and a power recovered by the battery during regenerative braking. Optionally, the method comprises determining the power allocation for the one or more units of the vehicle combination such that the total power delivered from the batteries during propulsion is below a threshold and/or the total power recovered by the batteries during regenerative braking is above a threshold.

Optionally, the method further comprises determining the power allocation for the one or more units of the vehicle combination such that the total power recovered by service brakes of the vehicle combination during regenerative braking is above a threshold.

Optionally, the power allocation for each unit is determined using an optimisation function to minimise the total power delivered from the batteries.

Optionally, the method further comprises determining a cost factor associated with each respective component of the power delivery expressed in the optimisation function.

Optionally, the method further comprises determining the power allocation for the one or more units of the vehicle combination such that a difference between the current state of charge of the batteries and a target value for the state of charge of the batteries is below a threshold.

Optionally, the method further comprises determining the power allocation for the one or more units of the vehicle combination such that a difference between the power delivered from the batteries and a target value for the power delivered from the batteries is below a threshold.

Optionally, the method further comprises determining a respective power delivery from each battery of the vehicle combination, and determining a power allocation for each unit of the vehicle combination.

According to another aspect of the disclosure, there is provided a computer program product comprising program code for performing the computer-implemented method when executed by a processor device.

According to another aspect of the disclosure, there is provided a control system comprising one or more control units configured to perform the computer-implemented method.

According to another aspect of the disclosure, there is provided a non-transitory computer-readable storage medium comprising instructions, which when executed by a processor device, cause the processor device to perform the computer-implemented method.

According to another aspect of the disclosure, there is provided a computer system comprising a processor device configured to perform the computer-implemented method.

According to another aspect of the disclosure, there is provided a vehicle comprising a processor device to perform the computer-implemented.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above-discussed technical benefits.

### BRIEF DESCRIPTION OF THE DRAWINGS

With reference to the appended drawings, below follows a more detailed description of aspects of the disclosure cited as examples.

FIG. 1A shows a first example vehicle combination.

FIG. 1B shows a second example vehicle combination.

FIG. 2 schematically shows an example control system for a vehicle combination.

FIG. 3 schematically shows an example power flow model for a vehicle combination.

FIG. 4 is a flowchart of an example method for determining a power allocation for a vehicle combination.

FIG. 5 is a flowchart of another example method for determining a power allocation for a vehicle combination.

FIG. 6 is a schematic diagram of an exemplary computer system for implementing examples disclosed herein, according to one example.

FIG. 7 is a schematic drawing of a computer readable medium according to one example.

FIG. 8 is a schematic block diagram of a control unit according to one example.

Like reference numerals refer to like elements throughout the description.

### DETAILED DESCRIPTION

Aspects set forth below represent the necessary information to enable those skilled in the art to practice the disclosure.

In vehicle combinations having a plurality of units, for example a tractor unit and one or more trailer units, batteries may be distributed across the various units in order to provide power to local propulsion systems such as electrical motors located on each unit. If a power allocation to meet the power demand of the vehicle combination is not adequately balanced across all units, significant degradation in performance may be observed. For example, the efficiency and range of the vehicle combination may be compromised when there are differences between units in how much energy can be regenerated when the vehicle is decelerating. Therefore, the service brakes in some of the vehicle units need to be used to maintain the balance of coupling forces between units.

To remedy this, methods are proposed for controlling the power allocation in multi-unit vehicle combinations with distributed propulsion and energy storage. A power flow model may be used to describe the power sources and losses involved in the motion of a multi-unit vehicle combination. Based on this model, an optimal power split between different units can be determined. The power split for each unit is determined with respect to the total power demand, for example including electrical machine power. The desired power split is determined between different units, and may also be determined within each unit. The determined power split can then be input to a motion coordination function that allocates the demands into motion support devices such as service brakes and electric motors.

This can be achieved by ensuring power losses are below a threshold, which may include ensuring actual losses are below a threshold, and/or ensuring recuperated power is above a threshold, such that the cumulative power losses of the vehicle combination are below a threshold. This can also be achieved by ensuring power delivered from the batteries during propulsion is below a threshold, which may include ensuring power delivered from the batteries during propulsion is below a threshold, and/or ensuring power recovered by the batteries during regenerative braking is above a threshold, such that the cumulative power delivered from the batteries of the vehicle combination, is below a threshold.

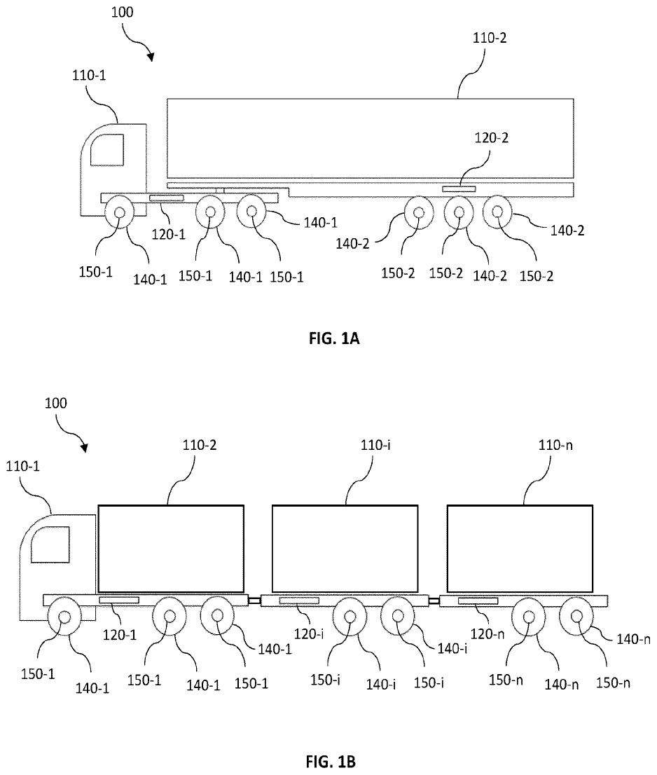

FIG. 1A schematically shows an example vehicle combination 100 of the type considered in this disclosure. The vehicle combination 100 comprises a number of units 110, including a tractor unit and at least one trailing unit. Only one trailing unit is shown, but it will be appreciated that the vehicle combination 100 may comprise further trailing units connected to each other. This gives rise to different types and designations of vehicle combinations.

A tractor unit, such as the tractor unit 110-1, is generally the foremost unit in a vehicle combination, and may comprise the cabin for the driver, including steering controls, dashboard displays and the like. Generally, the tractor unit 110-1 is used to provide propulsion power for the vehicle combination 100. A trailing unit, such as the trailing unit 110-2, is generally used to store goods that are being transported by the vehicle combination 100. A trailing unit may be a truck, trailer, dolly and the like. A trailing unit may also provide propulsion to the vehicle combination 100. A trailing unit without a front axle, such as the trailing unit 110-2, is known as a semi-trailer. In vehicle combinations such as that shown in FIG. 1A, vehicle motion management is available on a unit level to receive requests from a manual or virtual driver to coordinate the propulsion, braking and steering.

Each unit 110 may comprise one or more batteries 120 configured to provide power to one or more electrical machines 130 (not shown) such as electric motors. The electrical machines 130 are configured to drive, e.g. provide torque and/or steering to, one or more axles or individual wheels 140 of the unit 110. In some examples, electric motors may also be operated as generators, in order for the electric motors to generate braking force when required. Furthermore, each unit 110 may comprise one or more sets of service brakes 150. As shown in FIG. 1A, the tractor unit 110-1 has one or more batteries 120-1, wheels 140-1, and one or more sets of service brakes 150-1. The trailing unit 110-2 has one or more batteries 120-2, wheels 140-2, and one or more sets of service brakes 150-2.

Whilst three tractor axles and three trailer axles are shown, it will be appreciated that any suitable number of axles may be provide on the respective units 110. It will also be appreciated that any number of the tractor axles and/or trailer axles may be driven axles, including zero (i.e. one of the units may include at least one driven axle while the other does not).

FIG. 1B schematically shows another example vehicle combination 100 of the type considered in this disclosure. Similarly to the vehicle combination 100 of FIG. 1A, the vehicle combination 100 of FIG. 1B comprises a number of units 110, including a tractor unit and at least one trailing unit. Each unit 110 may be given an index i, and the total number of units in a vehicle combination is designated n.

The tractor unit 110-1 is generally the same as the tractor unit 110-1 of FIG. 1A. In this example, however, the tractor unit 110-1 may also be used to store goods that are being transported by the vehicle combination 100. The trailing units may be a truck, trailer, dolly and the like. All units 110 may provide propulsion to the vehicle combination 100.

Each unit 110 may comprise one or more batteries 120 configured to provide power to one or more electrical machines 130 (not shown) such as electric motors. Each unit 110 may comprise one or more sets of service brakes 150. As shown in FIG. 1B, the tractor unit 110-1 has one or more batteries 120-1, wheels 140-1, and one or more sets of service brakes 150-1. The unit 110-i has one or more batteries 120-i, wheels 140-i, and one or more sets of service brakes 150-i. The unit 110-n has one or more batteries 120-n, wheels 140-n, and one or more sets of service brakes 150-n. Whilst three tractor axles and two trailer axles are shown, it will be appreciated that any suitable number of axles may be provide on the respective units 110. It will also be appreciated that any number of the tractor axles and/or trailer axles may be driven axles, including zero (i.e. one of the units may include at least one driven axle while the other does not).

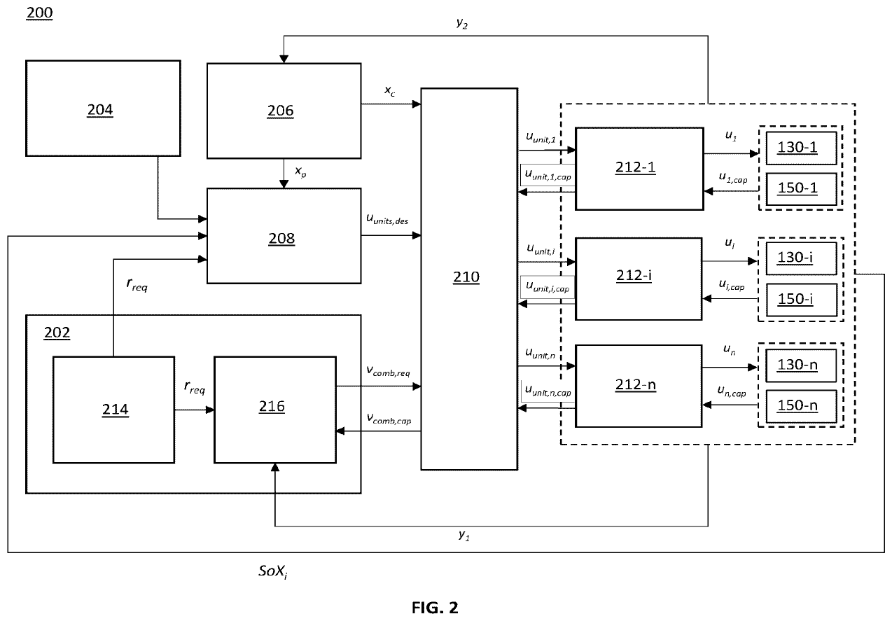

FIG. 2 schematically shows, in terms of functional blocks, an example control system 200 for a vehicle combination (e.g., any of the vehicle combinations 100 of FIGS. 1A and 1B). The control system 200 serves to perform various functions of the vehicle combination 100, such as power management and motion coordination. The control system 200 comprises a target generator 202, a tactical layer 204, a state estimator 206, a power manager 208, a combination control allocator 210 and a plurality of unit control allocators 212. The various modules may e.g. be implemented as code running on a processing circuitry, or similar. The various modules may be communicatively connected or connectable to each other, for example as known in the art.

The purpose of the target generator 202 is to determine a desired reference input r_{req} and a virtual control input v_{comb,req} for the vehicle combination 100. The desired reference input r_{req} is determined based on an input related to a manoeuvre for the vehicle combination 100. The virtual combination control input v_{comb,req} is determined based on the desired reference input r_{req} and a motion capability v_{comb,cap} for the vehicle combination 100. The target generator 202 comprises a path planner/controller 214 and a force generator 216.

The target generator 202 may receive an input related to a manoeuvre for the vehicle combination 100. The manoeuvre may be, for example, straight-line driving, cornering, braking and the like. The target generator 202 may receive a signal from, for example, a steering wheel and/or gas/brake pedal of the combination unit 100, indicating that the driver (or some other system of the vehicle combination 100) wants to change the direction and/or the speed of the vehicle combination in a certain way. In some examples, the signal may originate from elsewhere, for example any other system that may provide some indication of how the overall forces of the vehicle combination 100 are to be influenced (e.g. steered, propelled or braked). For example, the signal may originate from a lane assist system, a lane following system, an emergency steering system, an emergency braking system, an automated or semi-automated drive system. Based on this input, the target generator 202 outputs a desired reference input r_{req}. In particular, the path planner/controller 214 determines the desired reference input r_{req}. The desired reference input r_{req} may comprise at least one of a longitudinal acceleration aₓ of the vehicle combination 100 as a whole or of a unit 110 of the vehicle combination 100 (for example the unit 100 comprising the combination control allocator 210), a longitudinal velocity vₓ₁ of the tractor unit 110-1, a lateral velocity v_{y1} of the tractor unit 110-1, a yaw rate ω_{z1} of at least one unit 110 of the vehicle combination 100, and a steering angle δ_{f,req} of the tractor unit 110-1.

The virtual combination control input v_{comb,req} is determined based on the desired reference input r_{req}. In particular, the force generator 216 determines the virtual combination control input v_{comb,req}. The virtual combination control input v_{comb,req} may include desired motion parameters for the vehicle combination 100. In particular, the forces and/or moments that need to be applied to the vehicle combination 100 as a whole in order to follow the desired reference input r_{req} are determined. The desired motion parameters included in the combination virtual control input v_{comb,req} of the vehicle combination 100 may comprise at least one of a longitudinal force Fₓₜₒₜ of the vehicle combination 100, a lateral force F_{ytot} of the vehicle combination 100, a longitudinal coupling force Fₑₓᵢ between each unit 110, a lateral coupling force F_{cyi} between each unit 110, and/or a yaw moment M_{zi} for each unit 110.

The virtual combination control input v_{comb,req} may also be determined based on state information y₁ from the different units 110 of the vehicle combination 100 and a motion capability v_{comb,cap} for the vehicle combination 100. The state information y₁ may include information from sensors of the vehicle combination 100 such as wheel speed sensors, inertial measurement units, articulation angle sensors and the like. The motion capability v_{comb,cap} of the vehicle combination 100 may describe the limits of motion parameters for safe operation of the vehicle combination 100. The motion capability v_{comb,cap} may comprise at least one of a longitudinal force F_{xtot,cap} of the vehicle combination 100, a lateral force F_{ytot,cap} of the vehicle combination 100, and a yaw moment M_{zi,cap} for each unit 110.

The virtual combination control input v_{comb,req} may be determined based on a vehicle model. The vehicle model can be any suitable model, for example a model known in the art. The model can be based on real tests, computer model simulations, a machine-learning model, or other suitable means known in the art. The vehicle model may provide motion prediction of the vehicle combination 100 by looking at previous steering input and acceleration input. The predication may include instabilities such as understeer or rollover risk, for example within a one second horizon. The model may be, for example, a single-track model, i.e., left and right wheels on a given axle are considered together. The real units can have axle groups with several axles, but in the model they are considered together. A tyre model can be used in combination with the vehicle model. The tyre model may take into account the cornering stiffness of the tyres of the vehicle combination.

The tactical layer 204 is responsible for ensuring that the trajectory for the whole combination 100 is obstacle free and collision free. The tactical layer 204 may also include predictive energy management, including battery targets, capabilities and statuses that determine how the energy sources of the vehicle combination 100 should be used for a whole mission. The tactical layer 204 may also provide a desired reference input in an autonomous driving case.

The state estimator 206 is responsible for processing state information y₂ from the different units 110 of the vehicle combination 100. For example, the state estimator 206 may receive information from sensors of the vehicle combination 100 such as wheel speed sensors, inertial measurement units, articulation angle sensors and the like and use this information to determine states for the vehicle combination 100 and the various units. The state estimator 206 may then output unit-specific state information xₚ to the power manager 208 and unit-specific state information x_{c} to the combination control allocator 210.

The power manager 208 determines a power split between the different units 110 of the vehicle combination 100. The power manager 208 may also determine a power split within each unit 110, meaning how the power demand is divided between the actuators (for example, the electrical machines 130, service brakes 150, and/or steering servo arrangements) of the unit 110. Inputs to the power manager 208 include the desired reference input r_{req} from the target generator 202 and the statuses SoX of the batteries 120 of the vehicle combination 100. The power manager 208 determines a power allocation and an associated power allocation input u_{units,des}, as will be explained below.

The control allocators 210, 212 determine how various actuators (for example, the electrical machines 130, service brakes 150, and/or steering servo arrangements) of the vehicle combination 100 are to be controlled in order to generate requested global forces of the vehicle combination 100 as a whole. The combination control allocator 210 and the various unit specific control allocators 212 together form a distributed control allocation system for the vehicle combination 100. In this system, the control allocation is performed on multiple levels, i.e. first on a level of the vehicle combination 100 as a whole, and then on a level of each vehicle unit 110 individually.

The combination control allocator 210 transforms the virtual combination control input v_{comb,req} from the target generator 202 into a true control input uᵤₙᵢₜₛ for the vehicle combination 100, describing appropriate motion parameters for each unit 110. The combination control allocator 210 also transforms the true combination control input uᵤₙᵢₜₛ into unit-specific virtual control inputs u_{unit,i} describing the forces that each respective unit 110 is to produce in order to provide the true control input uᵤₙᵢₜₛ of the vehicle combination 100.

The unit control allocators 212 comprise a specific control allocator 212 for each unit 110 of the vehicle combination 100. The unit-specific virtual control inputs u_{unit,i} that are output from the combination control allocator 210 are distributed into unit-specific true control inputs uᵢ, describing actual actuator commands by the unit specific control allocators 212. For example, the unit specific control allocators 212 map the forces and moments of each unit 110 into the steering and drive/brake torques to be applied at the wheels 140 of each unit 110.

In some examples, the actuators of a particular unit 110 may be capable of estimating their own capabilities u_{unit,i,cap}, e.g. how much and/or how fast the actuators can move at a current time instant. For example, as shown in FIG. 2, the actuators of each unit 110 may provide an actuator capability u_{i,cap} to the respective unit control allocation module 212-i, which provides a force capability u_{unit,i,cap} to the combination control allocation module 210.

A more detailed description of the control allocation for the vehicle combination 100 is disclosed in co-pending PCT patent application PCT/EP2022/065415, which was filed in the name of the same applicant (Volvo Truck Corporation) as this patent application on 7 Jun. 2022, and in co-pending PCT patent application titled “Control Allocation for Multi-Unit Vehicle Combinations”, which was filed in the name of the same applicant (Volvo Truck Corporation) and on the same date (17 Nov. 2022) as this patent application.

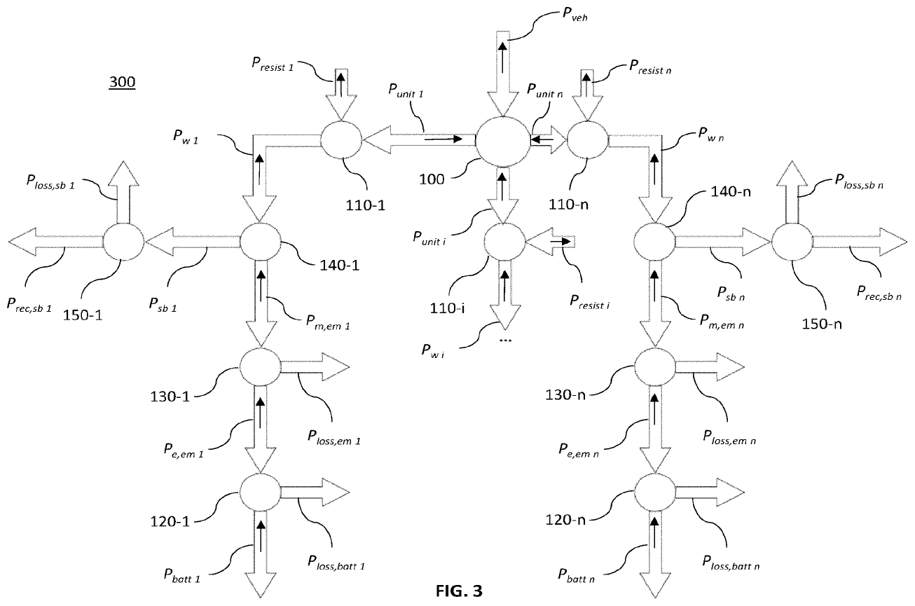

FIG. 3 shows a power flow model 300 for a vehicle combination 100. The power flow model 300 includes the power demands, supplies and losses for an entire vehicle combination.

The total power demand for the vehicle combination 100 is designated Pᵥₑₕ. This is the power required for acceleration or constant speed of the vehicle combination 100. The total power demand Pᵥₑₕ describes the power required for the vehicle combination 100 to perform a certain manoeuvre, such as straight-line driving, cornering, braking and the like. The total power demand Pᵥₑₕ may be determined by the target generation layer 202 of a control system 200 of the vehicle combination 100. For example, the power demand Pᵥₑₕ may be determined by multiplying the overall desired force from the reference input r_{req} by the current velocity of the vehicle combination 100. This may be based on overall control parameters for the vehicle, or may include control on a unit basis. For example if one unit is on a flat surface and another unit is on a slope, different control parameters will be required for each unit.

The total power demand Pᵥₑₕ is split between the various units 110 of the vehicle combination 100. A power demand for a particular unit 110-i is given as P_{unit i}. The maximum power demand P̅_̅{̅u̅n̅i̅t̅ i̅}̅ for a unit 110-i may be limited by a maximum power deliverable at the wheels 140-i of the unit, which can include limits on the capabilities of the electrical machines 130-i of the unit, road friction, normal loads, and factors for lateral/longitudinal motion. A minimum power demand P_{unit i} for a unit i may be set. The maximum and minimum power demands may be used to ensure that a difference in power demands between consecutive units is limited, in order to limit coupling forces or differences in longitudinal accelerations between units. As shown in FIG. 3, the tractor unit 110-1 has a power demand P_{unit 1}, and the trailing unit 110-n has a power demand of P_{unit n}.

The power demand P_{unit i} at each unit 110-i is split into the power P_{wi} to be delivered at the wheels 140-i of the unit 110-i and the power loss P_{resist i} due to resistive forces. The power P_{resist i} lost to resistive forces may comprise power lost to forces such as air resistance, friction, gravitational resistance due to road slope, and the like. As shown in FIG. 3, the tractor unit 110-1 has a power demand P_{w 1} to be delivered at the wheels 140-1 of the tractor unit 110-1, and a power loss P_{resist 1} due to resistive forces. The trailing unit 110-n has a power demand P_{w n} at the wheels 140-n of the unit and a power loss P_{resist n} due to resistive forces.

The remainder of the power model is shown only for units 110-1 and 110-n, but it will be appreciated that the model applies to all units 110-i, which will be used to describe the general case.

The power P_{w i} to be delivered at the wheels 140-i of each unit 110-i is split into the mechanical power P_{m,em i} delivered by the electrical machines 130-i and the power P_{sb i} delivered by the service brakes 150-i during regenerative braking. The maximum power P̅_̅{̅m̅,̅e̅m̅ ι̅}̅ delivered by the electrical machines 130-i may be limited based on the operational speed of the electrical machines 130-i and the status of the electrical machines 130-i. In particular, the operational speed of an electrical machine may be dependent on the gear ratio between the wheel speed and the electric machine speed. As shown in FIG. 3, the tractor unit 110-1 has a mechanical power P_{m,em 1} delivered to the electrical machines 130-1 of the tractor unit 110-1, and a power P_{sb 1} delivered to the service brakes 150-1 of the tractor unit 110-1. The trailing unit 110-n has a mechanical power P_{m,em n} delivered to the electrical machines 130-n of the trailing unit 110-n, and a power P_{sb n} delivered to the service brakes 150-n of the trailing unit 110-n.

The power P_{m,em i} delivered by the electrical machines 130-i of each unit 110-i is split into the electrical power P_{e,em i} delivered from the batteries 120-i, and power losses P_{loss,em i} from the electrical machines 130-i, including the transmission, for example due to heat. As shown in FIG. 3, the tractor unit 110-1 has an electrical power P_{e,em 1} delivered from the batteries 120-1 and power losses P_{loss,em 1} from the electrical machines 130-1. The trailing unit 110-n has an electrical power P_{e,em n} delivered from the batteries 120-n and power losses P_{loss,em n} from the electrical machines 130-n.

The power P_{sb i} delivered by the service brakes 150-i of each unit 110-i is split into the thermal recovery power P_{rec,sb i} from the service brakes 150-i, and power losses P_{loss,sb i} from the service brakes 150-i, for example to due to heat. The thermal recovery power P_{rec,sb i} from the service brakes 150-i is a result of regenerative braking, where the kinetic energy of a braking vehicle that would otherwise be lost as heat is converted into a useful form. In current systems, the thermal recovery power P_{rec,sb i} from the service brakes 150-i is often zero. As shown in FIG. 3, the tractor unit 110-1 has a thermal recovery power P_{rec,sb 1} from the service brakes 150-1 and power losses P_{loss,sb 1} from the service brakes 150-1. The trailing unit 110-n has a thermal recovery power P_{rec,sb n} from the service brakes 150-n and power losses P_{loss,sb n} from the service brakes 150-n.

The electrical power P_{e,em i} delivered from the batteries 120-i of each unit 110-i is split into the actual power P_{batt i} delivered from the batteries 120-i and power losses P_{loss,batt i} from the batteries 120-i including any converter. For example, the efficiency of a battery 120 is related to its SoC, and there may also be losses due to heat. The actual power P_{batt i} may be comprised of two components: a power P_{batt iP>0} delivered from the batteries 120-i during propulsion, and a power P_{batt iP<0} recovered by the batteries 120-i during regenerative braking. The maximum actual power P̅_̅{̅b̅a̅t̅t̅ i̅}̅ delivered from the batteries 120-i may be limited by the state of power of the batteries 120-i, which describes how much power the battery is able to deliver at a given time. Part of the power P_{batt iP<0} recovered by the batteries 120-i during regenerative braking may be provided by the power P_{sb i} delivered by the service brakes 150-i of each unit 110-i. As shown in FIG. 3, the tractor unit 110-1 has a battery power P_{batt 1} and power losses P_{loss,batt 1} from the battery 120-1. The trailing unit 110-n has a battery power P_{batt n} and power losses P_{loss,batt n} from the battery 120-n.

The power model 300 can be expressed formulaically as follows:

$${P}_{v e h} = {P}_{unit 1} + … + {P}_{unit i} + … + {P}_{unit n} = {F}_{x} * {v}_{x} \qquad ( 1 )$$

$${F}_{x} = {m}_{t} * {a}_{x , r e q} \qquad ( 2 )$$

$${P}_{unit i} = {P}_{w i} - {P}_{resist i} \qquad ( 3 )$$

$${P}_{w i} = {P}_{sb i} + {P}_{m , em i} \qquad ( 4 )$$

$${P}_{sb i} = {P}_{rec , sb i} - {P}_{l o s s , sb i} \qquad ( 5 )$$

where vₓ is the longitudinal speed of the vehicle combination 100, a_{x,reg} is the requested longitudinal acceleration from the reference input r_{req}, mₜ is the total mass of the vehicle combination 100, P_{sb i≤0}, and P_{loss,X≥0}.

The power flow model 300 can be used as a basis for determining a power allocation for the vehicle combination 100. In particular, given the total power demand Pᵥₑₕ for the vehicle combination 100, a power allocation across the various units 110 can be determined that can be optimised in a certain way. In one example, the power allocation can be determined such that the cumulative power losses of the vehicle combination 100 are below a threshold. In one example, the power allocation can be determined such that the cumulative power delivered from the batteries is below a threshold.

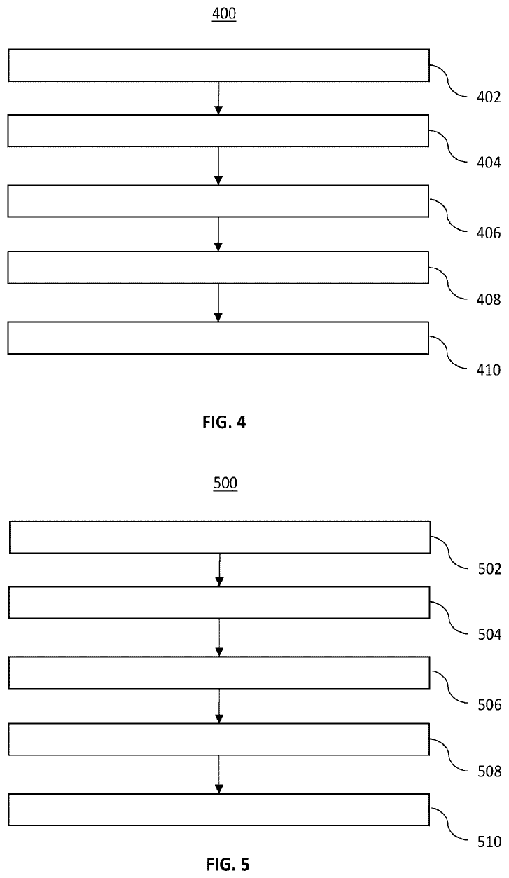

FIG. 4 is a flowchart of an example method 400 for determining a power allocation for a vehicle combination 100. The method 400 may be performed by the power manager 208 of a control system 200 of a vehicle combination 100. Whilst the method 400 is described as determining a power allocation across different units 110 of a vehicle combination, it will be appreciated that the same method could also be used to balance battery packs within the same unit 100 if they are connected to different electrical machines 130.

At step 402, a power demand Pᵥₑₕ is received for the vehicle combination 100. As discussed above, the total power demand Pᵥₑₕ describes the power required for the vehicle combination 100 to perform a certain manoeuvre, and is received from the target generator 202 of a control system 200 of the vehicle combination 100.

At step 404, the respective power losses associated with one or more units 110 of the vehicle combination 100, for example the power losses associated with each unit 110 of the vehicle combination 100, are determined. That is to say, it is determined to which particular power losses each particular unit 110 is susceptible. Each unit 110 may be susceptible to power losses P_{loss,batt i} from the batteries 120, power losses P_{loss,em i} from the electrical machines 130, and power losses P_{loss,sb i} from the service brakes 150. For example, a unit 110-i having one or more electrical machines 130-i may be susceptible to power losses P_{loss,em i} from the electrical machines 130-i, whereas a unit 110-i without electrical machines 130-i would not be susceptible to such power losses.

At step 406, a respective power capability of one or more batteries 120, for example a power capability of each battery 120, may optionally be received. The power capability may be defined by a battery status SoXᵢ of the batteries 120. The battery statuses SoXᵢ may be provided to the power manager 208 from one or more units 110. The battery statuses may include the state of charge (SoC), state of health (SoH), state of power (SoP), and/or state of energy (SoE) of each battery 120. In particular, the battery statuses SoXᵢ may include current values for the SoC, SoH, SoP, and/or SoE of each battery 120. The battery statuses SoXᵢ may also include minimum and maximum values for the SoC, SoH, SoP, and/or SoE of each battery 120. The battery statuses SoXᵢ may also include an SoC rate of change and/or an SoP input/output capability of each battery 120.

At step 408, a power allocation for one or more units 100 of the vehicle combination 100, for example a power allocation for each unit 100 of the vehicle combination 100, is determined. It is ensured that the total power allocation of the individual units 110 meets the received power demand Pᵥₑₕ for the vehicle combination 100. In particular, it may be ensured that the power required by the vehicle combination 100 to perform a particular manoeuvre is supplied by the combination of individual units 110.

In particular, the power allocation is determined such that the cumulative power losses of the vehicle combination 100 are below a threshold. For example, an acceptable value for the total power losses of the vehicle combination 100 can be determined and implemented as an upper limit for the power losses. The power allocation can then be determined such that the cumulative power losses of the vehicle combination 100 are below that value. This can be achieved using an optimisation function to minimise the cumulative power losses of the vehicle combination 100. Alternatively, this can be achieved, for example, using rule-based methods of machine learning methods.

An optimisation function to minimise the cumulative power losses may be given as follows:

$$min {\sum }_{i = 1}^{n} {c}_{sb i} {P}_{loss , sb i} + {c}_{em i} {P}_{loss , em i} + {c}_{batt i} {P}_{loss , batt i} \qquad ( 6 )$$

where c_{sb i}, c_{em i}, and c_{batt i} represent cost factors for the power losses of the service brakes 150-i, electrical machines 130-i, and battery 120-i respectively of the unit i. The optimisation function may also implement equality/inequality constraints for the capabilities of the various components and the power input/output of the batteries 120.

The optimisation function in equation (6) serves to minimise the cumulative power losses from the batteries 120-i, the electrical machines 130-i, and the service brakes 150-i. The optimisation function operates by modelling different power allocations and determining which minimises the function. In some examples, only the power losses from the service brakes 150-i may be considered. In some examples, the power losses from the service brakes 150-i may be considered along with the power losses from the batteries 120-i and/or the power losses from the electrical machines 130-i.

In some examples, the thermal recovery power P_{rec,sb i} from the service brakes 150-i can be taken into account in the optimisation function. In this case, it can be ensured that the thermal recovery power P_{rec,sb i} from the service brakes 150-i is above a threshold, for example maximised, in order to offset the power losses.

The cost factors c_{sb i}, c_{em i}, and c_{batt i} can be set appropriately in order to tune the optimisation function for different outcomes. The cost factors could be calculated based on current operating conditions, but also based on future operating conditions by receiving look-ahead information, for example from the tactical layer 204.

In one example, the use of the service brakes 150-i for a particular unit 110-i may be prioritised by setting a lower cost factor for that unit with respect to the cost factor of the other units. This may be the case if the service brakes 150-i for that particular unit have less wear or a lower temperature than the other units. It will be appreciated that the opposite case (higher cost factor for a unit with more wear or a higher temperature) may also be implemented. This is called minimising brake wear control and may be performed for low brake forces. If higher brake forces are requested, the braking may be distributed based on the normal loads of each axles in each unit 110 such that the coupling forces between units are balanced.

In another example, the use of the electrical machines 130-i for a particular unit 110-i may be deprioritised by setting a higher cost factor for that unit with respect to the cost factor of the other units. This may be the case if the electrical machines 130-i for that particular unit have a higher temperature than the other units. It will be appreciated that the opposite case (lower cost factor for a unit with a lower temperature) may also be implemented.

In another example, charging a battery 120-i of a particular unit 110-i may be prioritised by setting a lower cost factor for that unit with respect to the cost factor of the other units. This may be the case if the battery 120-i for that particular unit has a lower state of charge (SoC) with respect of the batteries of the other units. Similarly, discharging a battery 120-i of a particular unit 110-i may be prioritised by setting a lower cost factor for that unit if the battery 120-i for that particular unit 110-i has a higher SoC with respect of the batteries 120 of the other units. A similar approach can be taken with the state-of-health (SoH) of the batteries 120.

The optimisation function may also include terms relating to a target value for the SoC of the batteries 120-i and a target value for the power P_{batt i} delivered from the batteries 120-i. Such an optimisation function may be given as follows:

$$min {\sum }_{i = 1}^{n} {c}_{sb i} {P}_{loss , sb i} + {c}_{em i} {P}_{loss , em i} + {c}_{batt i} {P}_{loss , batt i} + {{λ}_{i} ( S o {C}_{target i} - S o {C}_{batt i} )}^{2} + {{ρ}_{i} ( {P}_{batt target i} - {P}_{batt i} )}^{2} \qquad ( 7 )$$

where λᵢ and ρᵢ represent cost factors for the SoC and battery power terms. As with the optimisation function in equation (6), the cost factors λᵢ and ρᵢ can be set appropriately in order to tune the optimisation function for different outcomes. The optimisation function may also implement equality/inequality constraints for the capabilities of the various components and the power input/output of the batteries 120.

In addition to the power losses considered in equation (6), the optimisation function in equation (7) serves to minimise the difference between the current SoC SoC_{batt i} of the batteries 120-i and a target value SoC_{target i}, and to minimise the difference between the power P_{batt i} delivered from the batteries and a target value P_{batt target i}. The current SoC can be determined in any suitable manner known in the art. In this way, the current SoC SoC_{batt i} and power P_{batt i} can be balanced with respect to a respective modelled value. This can be useful when it is desired to balance the SoC or power of different batteries, and/or when it is desired to follow the values from an upper-level controller such as the tactical layer 204.

As discussed above, the power losses from the service brakes 150-i may be considered alone, or in combination with the power losses from the batteries 120-i and/or the power losses from the electrical machines 130-i. These various combinations may also be considered with the SoC target and/or the battery power target.

At step 410, a power allocation input u_{units,des} may optionally be determined. The power allocation input u_{units,des} is a set of desired motion parameters that satisfies the power allocation for the vehicle combination 100. The power allocation input u_{units,des} may be formulated as follows:

$${u}_{units , d e s} = [ {u}_{{F}_{x , des}} , {u}_{{F}_{y , des}} , {u}_{{M}_{z , des}} ] \qquad ( 4 )$$

$${u}_{{F}_{x , des}} = [ {F}_{x , e l 1 , des} , {F}_{x , sb 1 , des} , {F}_{x , e l 2 , des} , {F}_{x , sb 2 , des} , … , {F}_{x , eln , des} , {F}_{x , sbn , d e s} ] \qquad ( 5 )$$

$${u}_{{F}_{y , des}} = [ {u}_{{F}_{y 1 , des}} , {u}_{{F}_{y 2 , des}} , … , {u}_{{F}_{yn , des}} ] \qquad ( 6 )$$

$${u}_{{M}_{z , des}} = [ {u}_{{M}_{z 1 , des}} , {u}_{{M}_{z 2 , des}} , … , {u}_{{M}_{z n , d e s}} ] \qquad ( 7 )$$

where F_{x,eli,des} is the desired aggregate electric machine force for unit i, F_{x,sbi,des} is the desired aggregate electric service brake force for unit i, u_{F}_{_{yi,des}} is the desired force for actuators that generate lateral force, and u_{M}_{_{z1,des}} is the desired force for actuators that generate yaw moment. The aggregate forces may be expressed as follows:

$${F}_{x , el i , des} = {P}_{m , em i} / max ( {v}_{x i} , ∈ ) \qquad ( 8 )$$

$${F}_{x , sb i , des} = {P}_{sb i} / max ( {v}_{x i} , ∈ ) \qquad ( 9 )$$

This method enables a power allocation to be determined for a vehicle combination that reduces losses, for example associated with batteries 120, electrical machines 130 and/or service brakes 150 of the vehicle combination 100. By reducing losses, efficient operation of the vehicle combination 100 can be ensured. This can be performed on a unit basis, such that an efficient distribution of the power demand is determined to fulfil the power requirement of the vehicle combination 100. Furthermore, the charging time of energy buffers can be reduced.

FIG. 5 is a flowchart of an example method 500 for determining a power allocation for a vehicle combination 100. The method 500 may be performed by the power manager 208 of a control system 200 of a vehicle combination 100. Whilst the method 500 is described as determining a power allocation across different units 110 of a vehicle combination 100, it will be appreciated that the same method could also be used to balance battery packs within the same unit 100 if they are connected to different electrical machines 130.

At step 502, a power demand Pᵥₑₕ is received for the vehicle combination 100. As discussed above, the total power demand Pᵥₑₕ describes the power required for the vehicle combination 100 to perform a certain manoeuvre, and received from the target generator 202 of a control system 200 of the vehicle combination 100.

At step 504, a respective power delivery from one or more batteries 120 of the vehicle combination 100, for example the power delivery from each battery 120 of the vehicle combination 100, is determined. That is to say, it is determined which units 110 comprise batteries 120 and which of these batteries 120 delivers power to the electrical machines 130. For example, a tractor unit 110-1 may be powered by an internal combustion engine and therefore not have a battery 120-1 driving an electrical machine 130-1. As discussed above, the actual power P_{batt i} delivered from a battery 120-i may be comprised of two components: a power P_{batt i P>0} delivered from the batteries 120-i during propulsion, and a power P_{batt i P<0} recovered by the batteries 120-i during regenerative braking. Some batteries 120, for example, may only deliver power during propulsion and not recover power during regenerative braking.

At step 506, a power capability of one or more batteries 120, for example a power capability of each battery 120, may optionally be received. The power capability may be defined by a battery status SoXᵢ of each battery 120, as discussed in relation to method 400.

At step 508, a power allocation for one or more units 100 of the vehicle combination 100, a power allocation for each unit 100 of the vehicle combination 100, is determined. It is ensured that the total power allocation of the individual units 110 meets the received power demand Pᵥₑₕ for the vehicle combination 100. In particular, it may be ensured that the power required by the vehicle combination 100 to perform a particular manoeuvre is supplied by the combination of individual units 110.

In particular, the power allocation is determined such that the cumulative power delivered from the batteries 120 of the vehicle combination 100 during operation is below a threshold. For example, an acceptable value for the total power delivered from the batteries 120 of the vehicle combination 100 can be determined and implemented as an upper limit for the power delivery. The power allocation can then be determined such that the cumulative power delivered from the batteries 120 of the vehicle combination 100 is below that value. This can be achieved using an optimisation function to minimise the cumulative power delivered from the batteries 120 of the vehicle combination 100. Alternatively, this can be achieved, for example, using rule-based methods of machine learning methods. It is to be noted that determination of cumulative power delivered from the batteries 120 is determined for operations of the vehicle combination 100, and does not include any separate discharging process.

An optimisation function to minimise the cumulative power delivered from the batteries may be given as follows:

$$min {\sum }_{i = 1}^{n} {c}_{batt i prop} {P}_{batt i P > 0} + {c}_{batt i regen} {P}_{batt i P < 0} \qquad ( 10 )$$

where c_{batt i P>0}, and c_{batt i P<0} represent cost factors for the power delivered from the batteries 120-i of the unit i during propulsion and regenerative braking respectively. The optimisation function may also implement equality/inequality constraints for the capabilities of the various components and the power input/output of the batteries 120.

The optimisation function in equation (10) serves to minimise the cumulative power delivered from the batteries 120-i. The optimisation function operates by modelling different power allocations and determining which minimises the function. It is to be noted that this means the power P_{batt i P>0} delivered from a battery during propulsion is minimised, and the power P_{batt i P<0} recovered by a battery during regenerative braking is maximised.

In some examples, the thermal recovery power P_{rec,sb i} from the service brakes 150-i may be considered. In this case, the thermal recovery power P_{rec,sb i} from the service brakes 150-i can be maximised in order to offset the power delivered from the batteries 120-i. Such an optimisation function may be given as follows:

$$min {\sum }_{i = 1}^{n} {c}_{batt i prop} {P}_{batt i P > 0} + {c}_{batt i regen} {P}_{batt i P < 0} + {c}_{sb i} {P}_{rec , sb i} \qquad ( 11 )$$

where c_{sb i} represents a cost factors for the service brakes 150-i. In some examples, at least part of the thermal recovery power P_{rec,sb i} from the service brakes 150-i may form part of the power P_{batt i P<0} recovered by the battery during regenerative braking.

The cost factors c_{batt i P>0}, c_{batt i P<0}, and c_{sb i} can be set appropriately in order to tune the optimisation function for different outcomes. The cost factors could be calculated based on current operating conditions, but also based on future operating conditions by receiving look-ahead information, for example from the tactical layer 202.

In one example, the use of a battery 120-i during propulsion for a particular unit 110-i may be prioritised by setting a lower cost factor for that unit 110-i with respect to the cost factor of the other units. This may be the case if the battery 120-i for that particular unit 110-i has a higher SoC with respect of the batteries 120 of the other units. It will be appreciated that the opposite case (higher cost factor for a unit with a lower SoC) may also be implemented

Similarly, the use of a battery 120-i during regenerative braking for a particular unit 110-i may be prioritised by setting a lower cost factor for that unit 110-i with respect to the cost factor of the other units if the battery 120-i for that particular unit 110-i has a lower SoC with respect of the batteries 120 of the other units. It will be appreciated that the opposite case (higher cost factor for a unit with a higher SoC) may also be implemented.

In this way, the battery having the lowest SoC would have the highest cost factor during propulsion such that it is discharged less. On the other hand, the battery having the lowest SoC would have the lowest cost factor during regenerative braking in order to increase its SoC level. In a similar way, a higher cost factor could be added to the battery of the unit with the largest deviation from the average SoC level of all the units in order to ensure a balance between the SoCs of all the batteries in the different units.

The optimisation function may also include terms relating to a target value for the SoC of the batteries 120-i and a target value for the power P_{batt i} delivered from the batteries 120-i. Such an optimisation function may be given as follows:

$$min {\sum }_{i = 1}^{n} {c}_{batt i prop} {P}_{batt i P > 0} + {c}_{batt i regen} {P}_{batt i P < 0} + {c}_{sb i} {P}_{rec , sb i} + {{λ}_{i} ( S o {C}_{target i} - S o {C}_{batt i} )}^{2} + {{ρ}_{i} ( {P}_{batt target i} - {P}_{batt i} )}^{2} \qquad ( 12 )$$

where λᵢ and ρᵢ represent cost factors for the SoC and battery power terms. As with the optimisation function in equations (10) and (11), the cost factors λᵢ and ρᵢ can be set appropriately in order to tune the optimisation function for different outcomes.

In addition to the power losses considered in equations (10) and (11), the optimisation function in equation (12) serves to minimise the difference between the current SoC SoC_{batt i} of the batteries and a target value SoC_{target i}, and to minimise the difference between the power P_{batt i} delivered from the batteries and a target value P_{batt target i}. The current SoC can be determined in any suitable manner known in the art. In this way, the current SoC SoC_{batt i} and power P_{batt i} can be balanced with respect to a respective modelled value. This can be useful when it is desired to balance the SoC or power of different batteries 120, and/or when it is desired to follow the values from an upper-level controller such as the tactical layer 202.

As discussed above, the power delivered from the batteries 120-i may be considered alone, or in combination with the thermal recovery power P_{rec,sb i} from the service brakes 150-i. These various combinations may also be considered with the SoC target and/or the battery power target.

At step 510, a power allocation input u_{units,des} may optionally be determined. The power allocation input u_{units,des} is a set of desired motion parameters that satisfies the power allocation for the vehicle combination 100, as discussed in relation to method 400.

This method enables a power allocation to be determined for a vehicle combination that reduces the power delivered from the batteries. This ensures that battery life can be increased and efficient operation of the vehicle combination can be ensured. This can be performed on a unit basis, such that an efficient distribution of the power demand is determined to fulfil the power requirement of the vehicle combination.

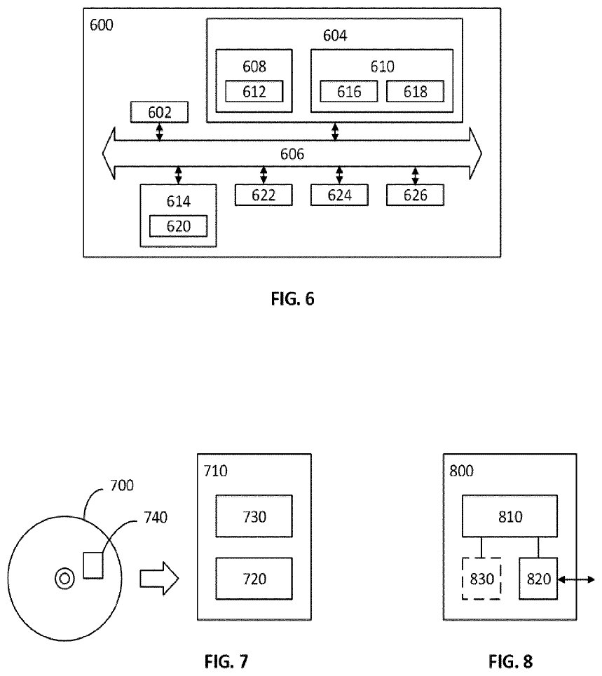

FIG. 6 is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include a processor device 602 (may also be referred to as a control unit), a memory 604, and a system bus 606. The computer system 600 may include at least one computing device having the processor device 602. The system bus 606 provides an interface for system components including, but not limited to, the memory 604 and the processor device 602. The processor device 602 may include any number of hardware components for conducting data or signal processing or for executing computer code stored in memory 604. The processor device 602 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processor device 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with a processor device 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program product 620 stored on a transitory or non-transitory computer-usable or computer-readable storage medium (e.g., single medium or multiple media), such as the storage device 614, which includes complex programming instructions (e.g., complex computer-readable program code) to cause the processor device 602 to carry out the steps described herein. Thus, the computer-readable program code can comprise software instructions for implementing the functionality of the examples described herein when executed by the processor device 602. The processor device 602 may serve as a controller or control system for the computer system 600 that is to implement the functionality described herein.

The computer system 600 also may include an input device interface 622 (e.g., input device interface and/or output device interface). The input device interface 622 may be configured to receive input and selections to be communicated to the computer system 600 when executing instructions, such as from a keyboard, mouse, touch-sensitive surface, etc. Such input devices may be connected to the processor device 602 through the input device interface 622 coupled to the system bus 606 but can be connected through other interfaces such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may also include a communications interface 626 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The described examples and their equivalents may be realized in software or hardware or a combination thereof. The examples may be performed by general purpose circuitry. Examples of general purpose circuitry include digital signal processors (DSP), central processing units (CPU), co-processor units, field programmable gate arrays (FPGA) and other programmable hardware. Alternatively or additionally, the examples may be performed by specialized circuitry, such as application specific integrated circuits (ASIC). The general purpose circuitry and/or the specialized circuitry may, for example, be associated with or comprised in an electronic apparatus such as a vehicle control unit.

The electronic apparatus may comprise arrangements, circuitry, and/or logic according to any of the examples described herein. Alternatively or additionally, the electronic apparatus may be configured to perform method steps according to any of the examples described herein.

According to some examples, a computer program product comprises a non-transitory computer readable medium such as, for example, a universal serial bus (USB) memory, a plug-in card, an embedded drive, or a read only memory (ROM). FIG. 7 illustrates an example computer readable medium in the form of a compact disc (CD) ROM 700. The computer readable medium has stored thereon a computer program 740 comprising program instructions. The computer program is loadable into a data processor (e.g., a data processing unit) 720, which may, for example, be comprised in a vehicle control unit 710. When loaded into the data processor, the computer program may be stored in a memory 730 associated with, or comprised in, the data processor. According to some examples, the computer program may, when loaded into, and run by, the data processor, cause execution of method steps according to, for example, any of the methods described herein.

FIG. 8 schematically illustrates, in terms of a number of functional units, the components of a control unit 800 according to some examples. The control unit may be comprised in a vehicle, e.g., in the form of a vehicle motion management (VMM) unit. A processor device in the form of processing circuitry 810 is provided using any combination of one or more of a suitable central processing unit (CPU), multiprocessor, microcontroller, digital signal processor (DSP), or similar; capable of executing software instructions stored in a computer program product, e.g. in the form of a storage medium 830. The processing circuitry 810 may further be provided as at least one application specific integrated circuit ASIC, or field programmable gate array FPGA.

Particularly, the processing circuitry 810 is configured to cause the control unit 800 to perform a set of operations, or steps; for example, any one or more of the methods discussed in connection to FIG. 4 and FIG. 5.

For example, the storage medium 830 may store a set of operations, and the processing circuitry 810 may be configured to retrieve the set of operations from the storage medium 830 to cause the control unit 800 to perform the set of operations. The set of operations may be provided as a set of executable instructions. Thus, the processing circuitry 810 is thereby arranged to execute methods as herein disclosed.

The storage medium 830 may comprise persistent storage, which, for example, can be any single one or combination of magnetic memory, optical memory, solid state memory or even remotely mounted memory.

The control unit 800 may further comprise an interface 820 for communication with at least one external device. As such, the interface 820 may comprise one or more transmitters and receivers, comprising analogue and digital components and a suitable number of ports for wireline or wireless communication.

The processing circuitry 810 controls the general operation of the control unit 800, e.g., by sending data and control signals to the interface 820 and the storage medium 830, by receiving data and reports from the interface 820, and by retrieving data and instructions from the storage medium 830. Other components, as well as the related functionality, of the control node are omitted in order not to obscure the concepts presented herein.

In some examples, the control unit 800 may be seen as a control system, or may be comprised in a control system. The control system may be configured for vehicle motion management (VMM). In some examples, the control system is configured to individually control vehicle units and/or vehicle axles and/or wheels of a multi-unit combination vehicle via a dynamic model of the vehicle, which is based on a detected order among vehicle units and/or a detected order among wheel axles.

Also disclosed are examples according to the following clauses:
A1. A computer-implemented method (400) for determining a power allocation for a vehicle combination (100) comprising a tractor unit and at least one trailing unit, the method comprising:
   receiving (402) a power demand for the vehicle combination;
   determining (404) respective power losses associated with one or more units (110) of the vehicle combination; and
   determining (408) a power allocation for the one or more units of the vehicle combination such that a cumulative power loss of the vehicle combination is below a threshold;
   wherein the total power allocation of the individual units meets the received power demand for the vehicle combination.
A2. The computer-implemented method (400) according to clause A1, wherein respective power losses associated with each unit (110) of the vehicle combination (100) comprise a power loss associated with service brakes (150) of the unit.
A3. The computer-implemented method (400) according to clause A1 or A2, wherein respective power losses associated with each unit (110) of the vehicle combination (100) comprise at least one of a power loss associated with a battery (120) of the unit, and a power loss associated with an electrical machine (130) of the unit.
A4. The computer-implemented method (400) according to any preceding clause, wherein respective power losses associated with each unit (110) of the vehicle combination (100) comprise a power recuperation associated with service brakes (150) of the unit, and the method comprises determining (408) a power allocation for the one or more units of the vehicle combination such that a cumulative power recuperation of the vehicle combination is above a threshold.
A5. The computer-implemented method (400) according to any preceding clause, wherein the power allocation for each unit (110) is determined using an optimisation function to minimise the total power losses of the vehicle combination (100).
A6. The computer-implemented method (400) according to clause A5, further comprising determining a cost factor associated with each of the respective component power losses for a unit (110) expressed in the optimisation function.
A7. The computer-implemented method (400) according to any preceding clause, further comprising determining the power allocation for the one or more units (110) of the vehicle combination (100) such that a difference between the current state of charge of the batteries (120) and a target value for the state of charge of the batteries is below a threshold.
A8. The computer-implemented method (400) according to any preceding clause, further comprising determining the power allocation for the one or more units (110) of the vehicle combination (100) such that a difference between the power delivered from the batteries (120) and a target value for the power delivered from the batteries is below a threshold.
A9. The computer-implemented method (400) according to any preceding clause, further comprising determining (404) respective power losses associated with each unit (110) of the vehicle combination and determining (408) a power allocation for each unit of the vehicle combination.
A10. A computer program product comprising program code for performing, when executed by a processor device, the computer-implemented method (400) of any of clauses A1 to A9.
A11. A control system comprising one or more control units configured to perform the computer-implemented method (400) of any of clauses A1 to A9.
A12. A non-transitory computer-readable storage medium comprising instructions, which when executed by a processor device, cause the processor device to perform the computer-implemented method (400) of any of clauses A1 to A9.
A13. A computer system comprising a processor device configured to perform the computer-implemented method (400) of any of clauses A1 to A9.
A14. A vehicle comprising the processor device to perform the computer-implemented method (400) of any of clauses A1 to A9.
B1. A computer-implemented method (500) for determining a power allocation for a vehicle combination (100) comprising a tractor unit and at least one trailing unit, the method comprising:
   receiving (502) a power demand for the vehicle combination;
   determining (504) a respective power delivery from one or more batteries (120) of the vehicle combination; and
   determining (508) a power allocation for one or more units (110) of the vehicle combination such that a cumulative power delivered from the batteries is below a threshold;
   wherein the total power allocation of the individual units meets the received power demand for the vehicle combination.
B2. The computer-implemented method (500) according to clause B1, wherein the power delivery from a battery (120) comprises a power delivered from the battery during propulsion, and a power recovered by the battery during regenerative braking.
B3. The computer-implemented method (500) according to clause B2, comprising determining (508) the power allocation for the one or more units (110) of the vehicle combination (100) such that the total power delivered from the batteries (120) during propulsion is below a threshold and/or the total power recovered by the batteries during regenerative braking is above a threshold.
B4. The computer-implemented method (500) according to any of clauses B1 to B3, further comprising determining (508) the power allocation for the one or more units (110) of the vehicle combination (100) such that the total power recovered by service brakes (150) of the vehicle combination during regenerative braking is above a threshold.
B5. The computer-implemented method (500) according to any of clauses B1 to B4, wherein the power allocation for each unit (110) is determined using an optimisation function to minimise the total power delivered from the batteries (120).
B6. The computer-implemented method (500) according to clause B5, further comprising determining a cost factor associated with each respective component of the power delivery expressed in the optimisation function.
B7. The computer-implemented method (500) according to any of clauses B1 to B6, further comprising determining (508) the power allocation for the one or more units (110) of the vehicle combination (100) such that a difference between the current state of charge of the batteries (120) and a target value for the state of charge of the batteries is below a threshold.
B8. The computer-implemented method (500) according to any of clauses B1 to B7, further comprising determining (508) the power allocation for the one or more units (110) of the vehicle combination (100) such that a difference between the power delivered from the batteries (120) and a target value for the power delivered from the batteries is below a threshold.
B9 The computer-implemented method (400) according to any of clauses B1 to B8, further comprising determining (504) a respective power delivery from each battery (120) of the vehicle combination, and determining (508) a power allocation for each unit of the vehicle combination.
B10. A computer program product comprising program code for performing, when executed by a processor device, the computer-implemented method (500) of any of clauses B1 to B9.
B11. A control system comprising one or more control units configured to perform the computer-implemented method (500) of any of clauses B1 to B9.
B12. A non-transitory computer-readable storage medium comprising instructions, which when executed by the processor device, cause a processor device to perform the computer-implemented method (500) of any of clauses B1 to B9.
B13. A computer system comprising a processor device configured to perform the computer-implemented method (500) of any of clauses B1 to B9.
B14. A vehicle comprising the processor device to perform the computer-implemented method (500) of any of clauses B1 to B9.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for determining a power allocation for a vehicle combination comprising a tractor unit and at least one trailing unit, the method comprising:
receiving a power demand for the vehicle combination;
determining a respective power delivery from one or more batteries of the vehicle combination; and
determining a power allocation for one or more units of the vehicle combination such that a cumulative power delivered from the batteries is below a threshold;
wherein the total power allocation of the individual units meets the received power demand for the vehicle combination.

2. The computer-implemented method according to claim 1, wherein the power delivery from a battery comprises a power delivered from the battery during propulsion, and a power recovered by the battery during regenerative braking.

3. The computer-implemented method according to claim 2, comprising determining the power allocation for the one or more units of the vehicle combination such that the total power delivered from the batteries during propulsion is below a threshold and/or the total power recovered by the batteries during regenerative braking is above a threshold.

4. The computer-implemented method according to claim 1, further comprising determining the power allocation for the one or more units of the vehicle combination such that the total power recovered by service brakes of the vehicle combination during regenerative braking is above a threshold.

5. The computer-implemented method according to claim 1, wherein the power allocation for each unit is determined using an optimisation function to minimise the total power delivered from the batteries.

6. The computer-implemented method according to claim 5, further comprising determining a cost factor associated with each respective component of the power delivery expressed in the optimisation function.

7. The computer-implemented method according to claim 1, further comprising determining the power allocation for the one or more units of the vehicle combination such that a difference between the current state of charge of the batteries and a target value for the state of charge of the batteries is below a threshold.

8. The computer-implemented method according to claim 1, further comprising determining the power allocation for the one or more units of the vehicle combination such that a difference between the power delivered from the batteries and a target value for the power delivered from the batteries is below a threshold.

9. The computer-implemented method according to claim 1, further comprising determining a respective power delivery from each battery of the vehicle combination, and determining a power allocation for each unit of the vehicle combination.

10. A computer program product comprising program code for performing, when executed by a processor device, the computer-implemented method of claim 1.

11. (canceled)

12. A non-transitory computer-readable storage medium comprising instructions, which when executed by the processor device, cause a processor device to perform the computer-implemented method of claim 1.

13. A computer system comprising a processor device configured to perform the computer-implemented method of claim 1.

14. A vehicle comprising the processor device to perform the computer-implemented method of claim 1.
